(19) United States
(12) Patent Application Publication
(10) Pub. No.: US 2017/0113808 A1
(43) Pub. Date: Apr. 27, 2017

(54) AIRCRAFT PNEUMATIC SYSTEM

(71) Applicant: ROLLS-ROYCE plc, London (GB)

(72) Inventor: Jonathan M. BOND, Bristol (GB)

(73) Assignee: ROLLS-ROYCE plc, London (GB)

(21) Appl. No.: 15/288,252

(22) Filed: Oct. 7, 2016

(30) Foreign Application Priority Data
Oct. 23, 2015 (GB) 1518788.3

(51) Int. Cl. B64D 41/00; B64D 13/06

(52) U.S. Cl. CPC B64D 41/00; B64D 13/06; B64D 2013/0618; B64D 2013/0644

(57) ABSTRACT

An aircraft pneumatic system comprises a gas turbine engine (10) comprising a compressor (14), a fan (12) and a core turbine (12) coupled to one of the compressor (14) and the fan (12), an auxiliary turbine (50) having an inlet in fluid communication with the core turbine (20), the auxiliary turbine (50) being configured to power an auxiliary compressor (40), an inlet of the auxiliary compressor (40) being in fluid communication with an outlet of the fan (12), and an outlet of the auxiliary compressor (40) being in fluid communication with an aircraft environmental control system (48).

The present disclosure concerns an aircraft pneumatic system and an aircraft having the pneumatic system.

Pressurised aircraft require a pneumatic system to pressurise internal spaces of the aircraft. In many cases, this air must also be heated and/or cooled, and must be of high quality (i.e. substantially free from toxins), particularly where the air is used for passenger cabins in commercial airliners.

Conventional aircraft pneumatic systems comprise a bleed air arrangement, in which air is bled from one or more main compressors of a main gas turbine engine. This bled air is then cooled using an air cycle machine comprising a compressor, heat exchanger, and turbine in series, with the compressor being driven by the turbine. The heat exchanger comprises an air to air heat exchanger, which exchanges heat from the bled air to air drawn from the engine fan duct or from an external ram air inlet. The bled air is then passed to the internal space of the aircraft.

However, where air is bled from the compressor, there is a risk that toxins from the engine oil system may be present in the bled air, thereby resulting in unacceptable air quality. Furthermore, the system may be heavy in view of the relatively large air to air heat exchanger. The system is also relatively inefficient at some stages of flight, since the bleed air system must be capable of supplying sufficient mass flow and pressure where the engine is run at relatively low power (and so the main engine compressor is running at a relatively low compression ratio). Consequently, an oversupply of pressure is supplied at all other conditions, leading to inefficiency. In some cases, multiple bleed air sources from different compressor stages are provided to partially alleviate this problem. However, such systems thereby incur further weight penalties and complexity. Furthermore, such systems require ducting from the area around the engine compressor, an area in which many components compete for space.

An alternative solution is to provide a dedicated compressor powered by an electric motor, which is in turn provided with electrical power from an engine driven generator. Such a system is used for example in the Boeing 787. However, in view of the conversion of mechanical power to electrical power, then back to mechanical power, these systems are also relatively inefficient. Such systems may also require hydraulic transmissions and/or power electronics, which add further weight.

A still further proposed solution is to directly drive a dedicated compressor using engine shaft power via an accessory gearbox driven continuously variable transmission (CVT). However, CVTs of the required power, efficiency, weight and reliability for this application have yet to be developed. Furthermore, such an arrangement may require large changes of various aspects of the engine, in order to accommodate increased shaft power takeoff.

A still further alternative solution is to use engine compressor bleed to drive a turbine, which in turn powers a dedicated compressor. In this solution, inlet air for the dedicated compressor is supplied from a source other than engine bleed air, such as fan duct air or ram inlet air, such that the compressor and turbine are not provided in fluid series, unlike the air cycle machine described above. Such a solution is described in US2010107594. In this arrangement the turbine discharge is mixed with the compressor discharge downstream of the compressor in order to compensate for the increased pressurisation required by the compressor. In view of this arrangement, toxins from the engine compressor may be mixed in with the air, and this system therefore suffers from similar problems to the air cycle machine system. This arrangement also still requires ducting in the region of the engine main compressor. In view of the varying pressure ratios provided by the compressor, the turbine may also require variable geometry features, thereby increasing cost and complexity, and requiring a sophisticated control regime.

According to a first aspect of the invention there is provided an aircraft pneumatic system comprising:

a gas turbine engine comprising a core compressor, a fan and a core turbine coupled to one of the core compressor and the fan;

an auxiliary turbine having an inlet in fluid communication with the core turbine;

the auxiliary turbine being configured to power an auxiliary compressor;

an inlet of the auxiliary compressor being in fluid communication with one or both of an outlet of the fan and an ambient air inlet, and an outlet of the auxiliary compressor being in fluid communication with a pressurised internal space of the aircraft.

Advantageously, the invention provides an aircraft pneumatic system that draws air from a clean air source to thereby provide air to an aircraft internal pressurised space, while being adaptable to existing aircraft gas turbine engines, and does not require installation of ducting in space constrained areas of the gas turbine engine core casing such as adjacent the engine core compressor.

The auxiliary compressor may be directly driven by the auxiliary turbine by an interconnecting shaft. The auxiliary compressor may comprise a centrifugal compressor. The auxiliary turbine may comprise a centrifugal turbine.

The gas turbine engine may comprise a high pressure shaft coupled to a high pressure core compressor and a high pressure core turbine, and a low pressure shaft coupled to a low pressure core compressor and a low pressure core turbine. The auxiliary turbine may be in fluid communication with the low pressure core turbine. The gas turbine engine may further comprise an intermediate pressure shaft coupled to an intermediate pressure core compressor and an intermediate pressure core turbine. The auxiliary turbine may be in fluid communication with one of the intermediate pressure core turbine and the low core pressure turbine. At least one of the auxiliary turbine and the auxiliary compressor may comprise variable inlet guide vanes.

The gas turbine engine may comprise a turbine casing which houses the core turbine. The gas turbine may comprise a core casing which houses the turbine casing, the core casing and turbine casing defining a core cavity therebetween. The auxiliary turbine may be located within the core cavity, and may be mounted to one or both of the turbine casing and the core casing. The auxiliary turbine may be located at the same axial position as the gas turbine engine core turbine, and may be located radially outwardly of the core turbine. Advantageously, the auxiliary turbine can be mounted without imposing excessive structural loads on the turbine casing, thereby preventing distortion of the turbine casing.

The gas turbine engine may comprise a turbine case cooling system comprising a manifold in thermal contact with the turbine casing, the manifold being in fluid communication with a fan outlet of the fan. An inlet of the case cooling system manifold and an inlet of the auxiliary compressor may be in communication with a common manifold supplied with fan air. Advantageously, existing ducting can be used to provide fan air to the auxiliary compressor, thereby reducing system complexity, and allowing the system to be retrofitted to existing gas turbine engines.

An outlet of the auxiliary turbine may communicate with a core vent nozzle of the gas turbine engine.

The system may comprise a further auxiliary turbine having an inlet in fluid communication with the gas turbine engine core turbine via a modulating valve, the further auxiliary turbine being configurable to power the auxiliary compressor. The further auxiliary turbine may be in fluid communication with a different stage of the core turbine than the auxiliary turbine. The further auxiliary turbine may be mechanically couplable with the auxiliary compressor via the interconnecting shaft and a clutch such as an overrunning clutch. The modulating valve may provide a leakage flow when in a closed position.

According to a second aspect of the present invention, there is provided an aircraft comprising the pneumatic system in accordance with the first aspect of the present invention.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

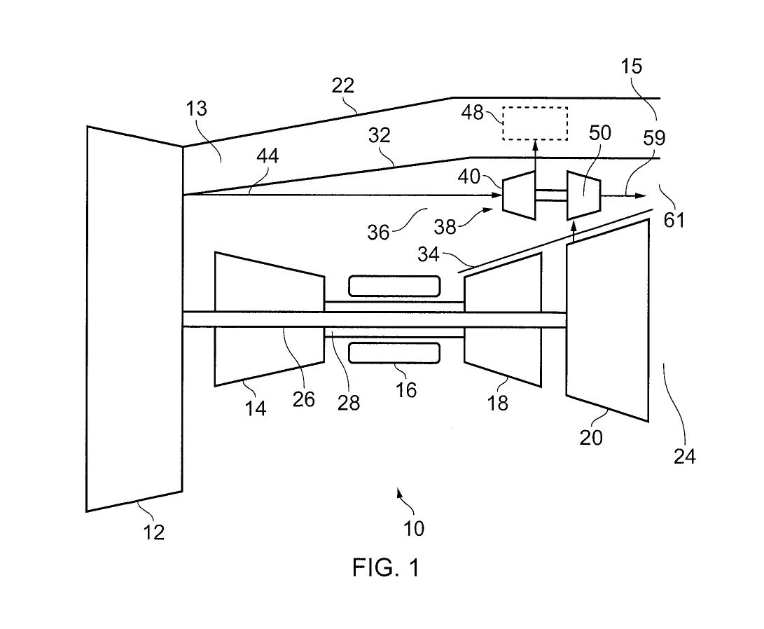

FIG. 1 is a diagrammatic sectional side view of a first pneumatic system;

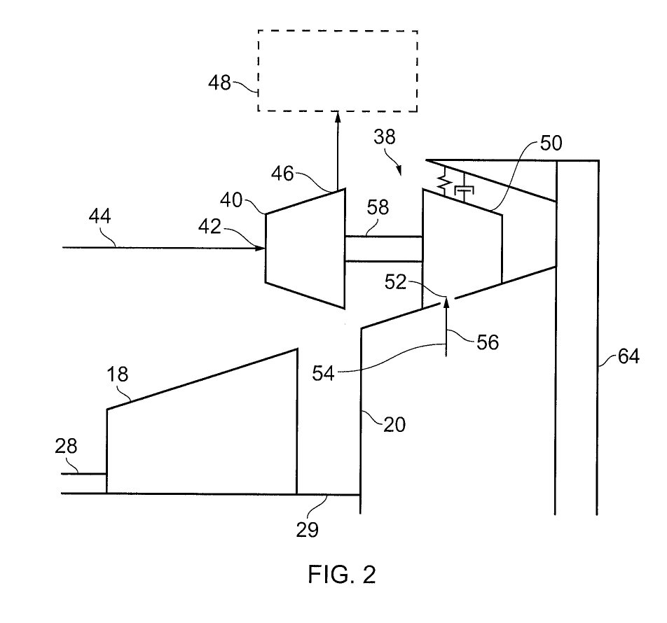

FIG. 2 is a diagrammatic side view of part of the pneumatic system of FIG. 1;

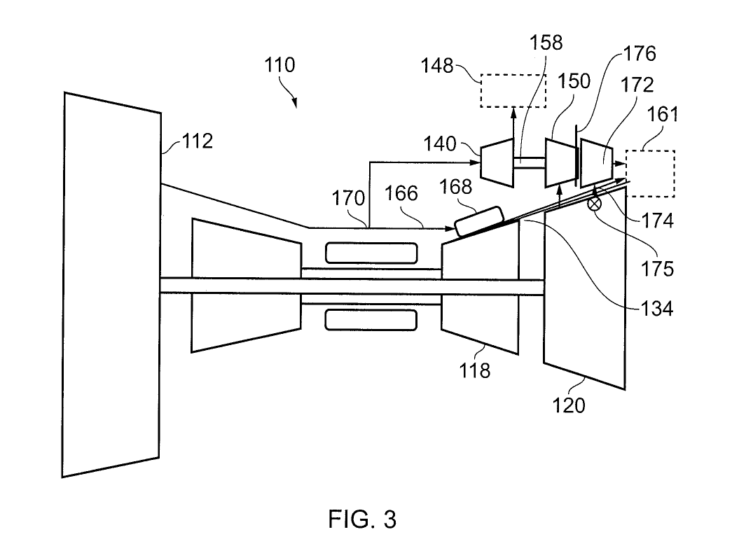

FIG. 3 is a diagrammatic sectional side view of a second pneumatic system; and

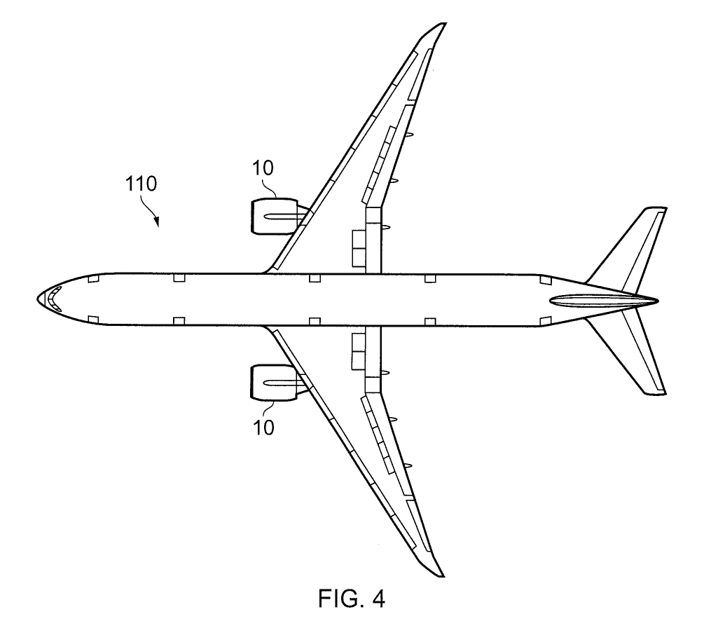

FIG. 4 is a plan view of an aircraft comprising the pneumatic system of any of FIGS. 1 to 3.

With reference to FIG. 1, a pneumatic system is disclosed. The pneumatic system comprises a gas turbine engine generally indicated at 10, having a principal and rotational axis. The engine 10 comprises, in axial flow series, a propulsive fan 12, a low compressor 14, combustion equipment 16, a high-pressure turbine 18 and a low-pressure turbine 20. A nacelle 22 generally surrounds the engine 10 and defines both an intake and a fan exhaust nozzle 15.

The gas turbine engine 10 works in the conventional manner so that air entering the intake is accelerated by the fan 12 to produce two air flows: a first air flow into the compressor 14 and a second air flow which passes through a bypass duct 13 defined by the nacelle 22 to provide propulsive thrust. The compressor 14 compresses the air flow directed into it before delivering that air to the combustion equipment 16 where it is mixed with fuel and the mixture combusted. The resultant hot combustion products then expand through, and thereby drive the high and low-pressure turbines 18, 20 before being exhausted through a core nozzle 24 to provide additional propulsive thrust. The high 18 and low 20 pressure turbines typically drive respectively the compressor 14 and fan 12, each by suitable interconnecting shafts 26, 28. Air flowing directly through the compressor 14, combustor 16 and turbines 20, 24 is known as “primary” or “core” engine flow, and is distinct from air bled from the compressor 14, which bypasses the combustor 16 before being used for purposes such as cooling engine components.

The gas turbine engine 10 further comprises an engine core casing 32 which is located radially inwardly of the nacelle 22. The core casing 32 houses the engine core components, including the compressor 14, combustor 1 and turbines 18, 20. Within the core casing is a turbine casing 34, which houses the turbines 18, 20. A cavity between the core casing 32 and turbine casing 34 defines a core cavity 36 in which an auxiliary turbo-compressor 38 is mounted. It should be noted that FIG. 1 is not to scale, and hence the relative dimensions of the components are not necessarily as shown. In most cases, the area within the core cavity radially outward of the turbines 18, 20 is less specially constrained than that radially outwardly of the compressor 14.

FIG. 2 shows the turbo-compressor 38 in more detail. The turbo-compressor 38 comprises an auxiliary compressor in the form of a centrifugal compressor 40. The centrifugal compressor 40 comprises an inlet 42 which is in fluid communication with the fan 12 via a duct 44 such that, in operation, air is supplied by the fan 12 to the auxiliary compressor inlet 42. In general, the duct 44 is at least partially flexible, to allow for misalignment between the fan and turbine, to thereby prevent excessive forces being applied to the core casing.

An outlet 46 of the compressor 40 is in fluid communication with an Environmental Control System (ECS) 48 which is configured to provide temperature controlled, pressurised air to an aircraft interior space, such as an aircraft cabin, cockpit or cargo area.

The compressor 40 is powered by an auxiliary turbine comprising a centrifugal turbine 50. An inlet 52 of the centrifugal turbine 50 is in fluid communication with the low pressure turbine 20 via a turbine bleed 54 (i.e. an aperture in the turbine casing 34) and a bleed duct 56, and so is powered by primary air flow downstream of a turbine stage. In general, the turbine bleed 54 is in communication with a turbine stage which receives core engine main flow gasses which are of a temperature which does not require secondary air cooling to maintain components below an acceptable operating temperature. Consequently, in some cases, the turbine bleed 54 could be located in fluid communication with the high pressure or intermediate pressure turbine, where present. The auxiliary turbine 50 comprises variable inlet guide vanes upstream of the rotor. The angle of the guide vanes can be varied to thereby control rotational speed and power output of the turbine 50 independently of inlet mass flow and pressure. Consequently, auxiliary compressor 40 speed can be controlled independently of gas turbine engine 10 throttle and other conditions. Similarly, the compressor 40 generally comprises variable inlet guide vanes to provide further independent control of compressor outlet pressure, independent of compressor inlet pressure and rotational speed. Consequently, full control of compressor outlet pressure can be maintained at a wide variety of engine and aircraft conditions.

In operation, the turbine bleed 54 provides high temperature, high pressure air to the turbine inlet 52, which in turn powers a rotor (not shown) of the auxiliary turbine 50. The rotor is in turn coupled to a rotor of the auxiliary compressor 40 via an interconnecting shaft 58 to thereby drive the compressor 40 in use, and thereby pressurise air provided to the ECS 48. An outlet 59 of the auxiliary turbine 50 is provided, which communicates with a core vent nozzle 61, which exhausts turbine exhaust air overboard, producing thrust.

Consequently, fan air provided by the fan 12 is compressed by the compressor 40 and fed to the ECS 48 using power extracted from gasses bled from the gas turbine engine turbine 20, which is converted to mechanical power by an auxiliary turbine 50.

FIG. 3 shows an alternative pneumatic system. The system comprises a gas turbine engine 110 similar to that of the pneumatic system of FIG. 1, with equivalent components labelled similarly to the embodiment of FIG. 1, but with the reference numerals incremented by 100. However, the gas turbine engine 110 further comprises a turbine case cooling system comprising one or more ducts 166 in fluid communication with an outlet of the fan 112, and which supplies fan air to a cooling manifold 168 in thermal contact with the turbine casing 134 radially outwardly of the high pressure turbine 118. When in operation, heat is transferred from the turbine casing 134 to the fan air, which is then exhausted through an exhaust duct (not shown), and out through the core vent nozzle 161. Valves (not shown) are provided to control supply of fan air to the cooling manifold 168, to thereby control the temperature of the turbine casing 134. Consequently, expansion of the turbine case can be controlled to match turbine blade expansion in use, to thereby prevent tip-rubs in service.

In this embodiment, fan air from the fan 112 is supplied to both the turbine case cooling system and the auxiliary compressor 140 inlet via a common manifold 170. Consequently, relatively little additional fan air ducting is required compared to systems having a turbine case cooling system.

In this embodiment, a second auxiliary turbine 172 is provided in addition to the first auxiliary turbine 150. An inlet of the second auxiliary turbine 172 is in fluid communication with a low pressure turbine 120 of the gas turbine engine 110 via a further bleed duct 174 and a modulating valve 175. The modulating valve is configurable between open and closed positions to thereby modulate the flow of turbine gasses into the second auxiliary turbine 172, to thereby control the power output of the second auxiliary turbine 172. In general, some leakage flow through the valve 175 is permitted when the valve 175 is closed. In this embodiment, the inlet of the second auxiliary turbine 172 is in fluid communication with a lower pressure turbine stage of the gas turbine engine 110 than the first auxiliary turbine 150. The second auxiliary turbine 172 comprises a rotor (not shown) which is coupled to the auxiliary compressor 140 via an interconnecting shaft 158, which also couples the first auxiliary turbine 150 to the auxiliary compressor 140 and extends through the first auxiliary turbine. The second auxiliary turbine 172 is coupled to the interconnecting shaft 158 via an overrunning clutch such as a spragg clutch 176. The overrunning clutch allows free rotation of the second auxiliary turbine 172 when the first auxiliary turbine 150 is rotating at a high rotational speed than the second auxiliary turbine 172, but applies a torque from the second auxiliary turbine 172 to the interconnecting shaft 158 when the first and second auxiliary turbines 150, 172 are running at the same speed. This may be the case where, for example, a higher load is imposed on the first auxiliary turbine 150 by the auxiliary compressor 140. This may be the case for example where the auxiliary compressor 140 is required to supply higher pressure air, or a higher flow rate in the event of a failure such as a cabin de-pressurisation event, or the failure of an ECS installed on a further gas turbine engine 110. Each of the first and second auxiliary turbines 150, 172 exhaust to ambient via the core vent nozzle 161.

The systems of either FIGS. 1 and 2 or FIG. 3 are employed in an aircraft 200 shown in FIG. 4. The aircraft 200 comprises a pair of gas turbine engines 10 (or 110), which are each associated with a respective, independent pneumatic system (such as shown in either FIGS. 1 and 2, or FIG. 3). Consequently, independent pneumatic systems are provided. In some cases, two or more turbo-compressor 38 may be provided for each engine 10, thereby providing still further redundancy.

The described invention thereby provides an efficient means of pressurising air in an aircraft pneumatic system. The pressurised air output to the ECS is less susceptible to contamination with toxins in view of the source of the air output to the ECS being sourced from fan outlet air. Less core mass flow is required to provide ECS pressurisation, in view of the cabin air flow being provided from non-core mass flow (i.e. fan flow), and driving airflow being provided by a turbine bleed (which is generally at a higher temperature than compressor bleed flow). In view of the higher temperature driving air, the cycle is more thermodynamically efficient.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein. For example, the case cooling arrangement of FIG. 3 could be employed with the single auxiliary turbine arrangement of FIG. 3 and vice versa.

The auxiliary turbine could be in fluid communication with the high pressure turbine of the gas turbine engine. The gas turbine engine could have three separate, independently rotatable turbines, i.e. high pressure, intermediate pressure and low pressure turbines coupled to a high pressure compressor, and intermediate pressure compressor and a fan respectively by respective shafts. Alternatively, in a two shaft arrangement, the low pressure shaft may be coupled to a core booster compressor upstream of the main compressor.

Further auxiliary compressors or turbines could be provided. The auxiliary compressors and/or turbines could be multi-stage and could be of any suitable type, such as axial or centrifugal flow. The auxiliary turbine could power the auxiliary compressor indirectly, such as via a gearbox. Alternatively, the auxiliary turbine could drive an electrical generator, which could provide electrical power to an electrically driven auxiliary compressor.

The auxiliary compressor could be supplied with air from an ambient pressure inlet, such as a ram air duct, which may be located on an external side of the engine nacelle. The turbo-compressor could be located remotely the engine, with ducting extending between the main engine turbine and auxiliary turbine.

1. An aircraft pneumatic system comprising:
a gas turbine engine (10) comprising a compressor (14), a fan (12) and a core turbine (20) coupled to one of the compressor (14) and the fan (12);
an auxiliary turbine (50) having an inlet in fluid communication with the core turbine (20);
the auxiliary turbine (50) being configured to power an auxiliary compressor (40);
an inlet of the auxiliary compressor (40) being in fluid communication with one or both of an outlet of the fan (12) and an ambient air inlet, and an outlet of the auxiliary compressor (40) being in fluid communication with an aircraft environmental control system (48).

2. A system according to claim 1, wherein the auxiliary compressor (40) is directly driven by the auxiliary turbine (50) by an interconnecting shaft (58).

3. A system according to claim 1, the auxiliary compressor (40) comprises a centrifugal compressor and/or the auxiliary turbine (50) comprises a centrifugal turbine.

4. A system according to claim 1, wherein the gas turbine engine (10) comprises a high pressure shaft (28) coupled to a high pressure compressor (14) and a high pressure turbine (18), and a low pressure shaft (26) coupled to a low pressure compressor and/or a low pressure fan (12) and a low pressure turbine (20).

5. A system according to claim 4, wherein the auxiliary turbine (50) is in fluid communication with the low pressure turbine (20).

6. A system according to claim 1, wherein at least one of the auxiliary turbine (50) and the auxiliary compressor (40) comprises variable inlet guide vanes.

7. A system according to claim 1, wherein the gas turbine engine comprise a turbine casing (34) which houses the core turbine (20), and a core casing (32) which houses the turbine casing (34), the core casing (34) and turbine casing (32) defining a core cavity (36) therebetween, wherein the auxiliary turbine is located within the core cavity (36).

8. A system according to claim 7, wherein the auxiliary turbine (50) is mounted to one or both of the turbine casing (34) and the core casing (32).

9. A system according to claim 1, wherein the gas turbine engine (110) comprises a turbine case cooling system comprising a manifold (168) in thermal contact with a turbine casing (134), the manifold (168) being in fluid communication with a fan (112) outlet of the gas turbine engine (110).

10. A system according to claim 9, wherein an inlet of the case cooling system manifold (168) and an inlet of the auxiliary compressor (140) may be in communication with a common manifold (170) supplied with fan air.

11. A system according to claim 1, wherein an outlet of the auxiliary turbine (50) communicates with a core vent nozzle (61) of the gas turbine engine (10).

12. A system according to claim 1, wherein the system comprises a further auxiliary turbine (172) having an inlet in fluid communication with the gas turbine engine core turbine (120), the further auxiliary turbine (172) being configurable to power the auxiliary compressor (140).

13. A system according to claim 12, wherein the further auxiliary turbine (172) is mechanically couplable with the auxiliary compressor (140) via the interconnecting shaft (158) and a clutch (176).

14. An aircraft (200) comprising a pneumatic system according to claim 1.
